(19) United States
(12) Patent Application Publication
(10) Pub. No.: US 2017/0228819 A1
(43) Pub. Date: Aug. 10, 2017

(54) ONLINE DATING SYSTEM AND METHOD

(71) Applicants: Alexander Azariy Shenkar, Roswell, GA (US); Rohit O. Rana, Marietta, GA (US)

(72) Inventors: Alexander Azariy Shenkar, Roswell, GA (US); Rohit O. Rana, Marietta, GA (US)

(21) Appl. No.: 15/157,381

(22) Filed: May 17, 2016

Related U.S. Application Data
(60) Provisional application No. 62/292,248, filed on Feb. 6, 2016.

(51) Int. Cl. G06Q 40/02

(52) U.S. Cl. CPC G06Q 40/025; G06Q 50/01

(57) ABSTRACT

Disclosed herein are computer implemented methods and systems for facilitating online dating by using credit bureau information. The systems and methods disclosed herein utilize credit information (e.g., credit report and/or credit score information) to predict relationship quality. In one embodiment, the credit information is attained from credit bureaus. In one embodiment, information is used within the disclosed systems and method to find suitable matches between dating prospects.

### CROSS REFERENCE TO RELATED APPLICATIONS

This application claims priority to U.S. Provisional Patent Application No. 62/292,248, filed Feb. 6, 2016.

### BACKGROUND

Online dating or Internet dating is a personal introductory system where individuals can find and contact each other over the Internet to arrange a date, usually with the objective of developing a personal, romantic, or sexual relationship.

Online dating services usually provide unmoderated matchmaking over the Internet, through the use of personal computers or cell phones. Users of an online dating services usually provide personal information, which enable them to search the service provider's database for other individuals. Members use criteria requested by the particular online dating platform, such as age range, gender and location.

Most online dating sites allow members to upload photos or videos of themselves and browse the photos and videos of others.

Some online dating sites may offer additional services, such as webcasts, online chat, telephone chat (VOIP), and message boards. Some sites provide free registration, but may offer services which require a monthly fee. Other sites depend on advertising for their revenue. Some sites such as OkCupid.com, POF.com, and Badoo.com are free and offer additional paid services in a freemium revenue model.

Some online dating sites are broad-based, with members coming from a variety of backgrounds looking for different types of relationships. Other sites are more specific, based on the type of members, interests, location, or relationship desired. A 2005 study of data collected by the Pew Internet & American Life Project found that individuals are more likely to use an online dating service if they use the internet for a greater amount of tasks and less likely to use such a service if they are trusting of others.

The online dating company Match.com asks users to answer basic questions such as age, gender, etc., then applies an algorithm that correlates this information with other similar users to providing dating recommendations.

The online dating company Zoosk uses past search history to recommend dating partners who are similar or related. The focus of the Zoosk technology is providing users with options as opposed to finding the “one”. The Zoosk technology includes methods of arranging meetings for people based on distance/location, matching people based on characteristics, and allowing people to see other people's profiles.

The online dating company OkCupid requires users to answer a series of “match questions” that indicate personality qualities and each user's indication of the importance thereof. Based on user response, OKCupid calculates a percentage of compatibility with other users.

The online dating company Howaboutwe allows the user to design a profile that emphasizes the user's personality and basic info, while avoiding questions that are superficial, obvious, and misleading. Howaboutwe aims to emphasize characteristics that enhance the process of going on successful dates. Their algorithm focuses on location, one user's interest in a specific user, opt-in status, and profile details. As a user on the Howaboutwe interacts with the site, the company gets a better sense for the user's unique preferences and the recommendation algorithms rely less on an ‘average person weighting’ and more on what is inferred from the user's behavior.

The online dating platform “Hot or Not” applies a method which focuses on user pictures. The computational pipeline comprises a face detector, convolutional neural networks for the extraction of deep features, standard support vector regression for gender, age and facial beauty, and—as the main novelty—visual regularized collaborative filtering to infer inter-person preferences as well as a novel regression technique for handling visual queries without rating history.

The online dating platform Hinge uses a combination of reviews of past dates, and past date attributes, focusing on finding successful matches within the user's social network, such as mutual Facebook friends. Accordingly, Hinge extracts information from social networking sites (e.g., Facebook), matching users with other users who went to the same kind of college (e.g., Ivy League, State School), or similar type of job (tech, finance, politics). Hinger refers to this output as a “Romance Graph”.

The online dating platform Tinder applies a GPS-based location-oriented system to determine nearby users, then uses social media information to create a profile for the user comprising first name, age, photos, and interests. Tinder's methods include accepting user input by having the user swipe left or right to indicate a level of preference for potential matches.

The online dating platform SpeeddateGranted applies a method of connecting people for a set period of time and then later soliciting feedback as to the quality of the interaction. SpeeddateGranted also includes a group date selection. See U.S. Pat. No. 7,203,674.

Despite the large number of online dating technologies, there still exists a need to accurately predict long term relationship success.

Before this disclosure, no online dating platform matched users based on verified credit bureau information, such as Credit scores (for example, FICO, which is commonly available from the credit bureaus), Credit attributes, and/or other public information contained in a credit report. No online dating platform included independently verified credit bureau information in a user's profile. Accordingly, before this disclosure, no online dating platform allowed users to share verified credit bureau information that was obtained from the credit bureau by an online dating system. Before this disclosure, no online dating platform presented users with commercial offers based on credit bureau information that was obtained from the credit bureau by an online dating system.

### BRIEF DESCRIPTION OF THE DRAWINGS

The following figures provide some illustrative examples of specific embodiments of the disclosed systems and methods. These figures should not be considered limiting to the scope of this disclosure in any way.

FIG. 1 illustrates an exemplary environment 100 for facilitating selection of dating partners in one or more social networks including connections among a plurality of subscribers. The environment 100 is specifically explained with reference to online dating; however, the current example of a dating environment should not be construed as a limitation to the scope of the present disclosure. Another application of the method may be to meet travel companions in an online environment.

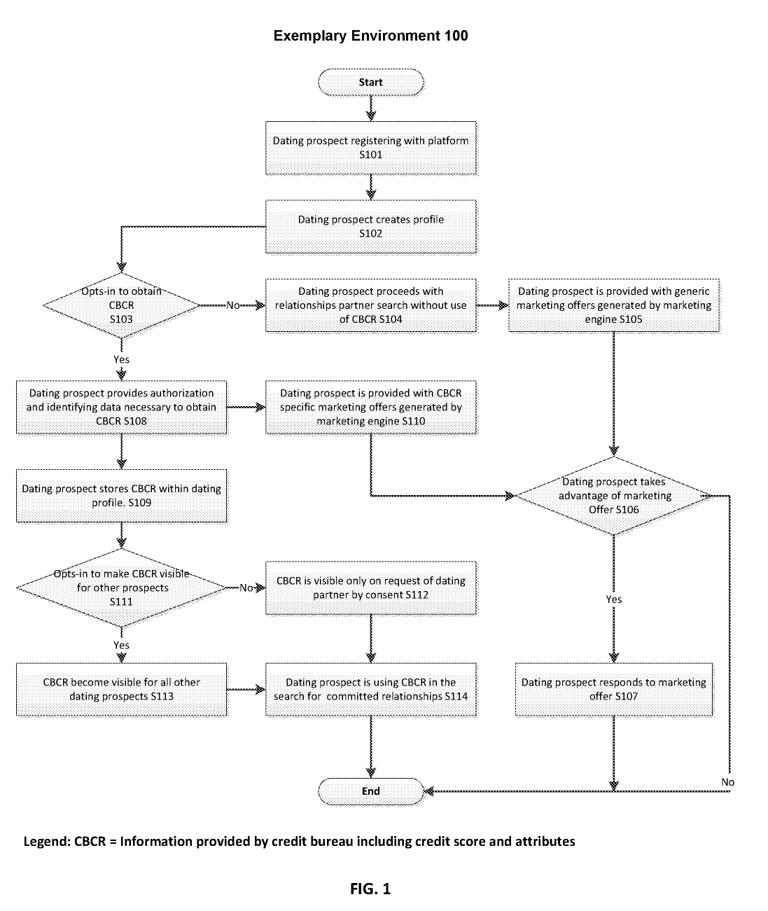

S101-102: Dating prospects (aka “users” or “subscribers”) register with the MIQ platform and complete their profile with basic demographic information describing what they are looking for in their prospective partner.

S103: Users have an option to voluntarily opt for obtaining their credit bureau score and also credit report (CBCR).

S104: In case when the dating prospect opts out of obtaining their CBCR they will have the option to continue to look for prospective partners without any CBCR.

S105: Users are presented with generic marketing efforts, however these advertisements will not be targeted as there is no CBCR related information is being displayed.

S108-109: Dating prospect opts in for CBCR and provides explicit consent to obtain the credit information which populates the following field: Credit scores; Credit Bureau Information including public records

S111: Dating prospect has the option to publish the CBCR and make it visible to all the other subscribers or only allow access only for selected subscribers based on their request.

S112: CBCR become visible on approved request for certain subscribers. CBCR owner has capability to approve or deny a request to access CBSR by other subscribers.

S113: A subscriber may decide to publish CBCR for all other subscribers registered in the system.

S114: Dating prospect uses CBCR to search for relationships partner.

S110: Dating prospect is provided targeted marketing information based on credit score and credit bureau information.

S106-107: Dating prospect takes advantage and responds to targeted marketing offers.

### DETAILED DESCRIPTION

Disclosed herein are computer implemented methods and systems for facilitating online dating by using credit bureau information. The methods and systems disclosed herein are generally applicable; they are not limited to a specific platform. Platforms may include virtually any computer, such as smart communication devices based on a mobile operating system including but not limited to iOS®, Android®, BlackBerry OS®, BlackBerry Tablet OS®, webOS®, Symbian OS®, bada®, Windows Mobile®, Windows Phone OS®, Maemo®, and MeeGo®. Further, the connectivity maybe be provided by be any suitable network such as the Internet, Wi-Fi, Wireless Local Area Network (WLAN), Wireless 3G Network, etc.

The systems and methods disclosed herein utilize credit information (e.g., credit report and/or credit score information) to predict relationship quality. In one embodiment, the predicted relationship quality is represented by a match or score, which is presented on a display means, such as a computer screen. In one embodiment, the credit information is attained from credit bureaus. In one embodiment, information is used within the disclosed systems and method to find suitable matches between dating prospects. In one embodiment, information is used within the disclosed systems and method to advise against pursuing a particular user as a potential relationship partner. In one embodiment, the systems and methods advise against pursuing a particular partner as a relationship partner based on a mismatch or dissimilarity in credit information, such as Credit scores (for example, FICO, which is commonly available from the credit bureaus); Credit attributes; and/or other public information contained in the credit report.

In some embodiments, the systems and methods disclosed herein provide information to prospective dating partners including, for example: Credit scores (for example, FICO, which is commonly available from the credit bureaus); Credit attributes; and/or other public information contained in the credit report.

Also disclosed are methods and systems for providing targeted advertising to users of online dating systems disclosed herein. In one embodiment, identifying information for a user of the online dating platform is received. In one embodiment, corresponding credit scores and/or credit report information are used to provide targeted offers to dating prospects. In one embodiment, one of more advertisements for presentation to the subscriber are selected based on the credit information (e.g., score range and other information) provided within the credit report.

Also disclosed herein is are methods and systems for facilitating a search for a committed relationship partner comprising evaluating credit information, such as credit scores and credit bureau information. In one embodiment, the credit bureau and credit score information is used as an indication of sustainability of union of long term relationship partners. In one embodiment, the credit information includes a credit score, such as FICO™, which is commonly available from the credit bureaus.

In one embodiment, the computer implemented systems and methods provide information to prospective dating partners. In one embodiment, the computer implemented systems and methods suggest a match based on information sourced from a credit bureau.

In one embodiment of the disclosed systems and methods, the profile of a system user includes personal details, pictures, and other relevant information that is present in other dating sites. In one embodiment, an information sharing method between subscribers allows anonymous sharing of credit bureau scores and credit bureau information between subscribers.

In some embodiments, the disclosed online dating system includes a First User, a Second User, an electronic connection between the First User and the online dating system, a display means, an electronic connection between the Second User and the online dating system, a means for determining Credit Information for the First User, a means for determining Credit Information for the Second User, comparing the Credit Information for the First User with the Credit Information for the Second User, and/or determining a Compatibility Score between the First User and the Second User.

In some embodiments, the electronic connection includes a personal computing platform connected to the internet.

In some embodiments, the online dating system includes a group of users having an electronic connection to the online dating system.

In some embodiments, the Credit Information includes data chosen from FICO score, debt, number of credit cards, bankruptcy.

In some embodiments, the Credit Information is verified for accuracy. In some embodiments, the Credit Information is verified by an independent entity. In some embodiments, the Credit Information is verified by an entity other than the online dating system.

In some embodiments, the online dating system includes profile information for the First User.

In some embodiments, the profile information is chosen from age, gender, location, photo, race, children, height, hobbies, occupation, educational background, and personality characteristics.

In some embodiments, the means for determining Credit Information includes establishing an electronic connection with a credit bureau, querying the credit bureau for a record associated with the First User, and collecting the Credit Information.

In some embodiments, the personal computing platform is chosen from a laptop computer, a desktop computer, a cell phone, or a mobile device.

In some embodiments, the Credit Information for the First User is publicly available to the group of users connected to the online dating system.

In some embodiments, the Credit Information for the First User is privately transmitted to the Second User without transmitting the Credit Information to the group of users.

In some embodiments, the online dating system includes Advertising Content.

In some embodiments, the Advertising Content is presented to the First User.

In some embodiments, the online dating system includes presenting Advertising Content to the First User, pursuant to the Credit Information for the First User.

In some embodiments, a method of matching a First Person with a Second Person for a committed relationship includes comparing the Credit Information of the First Person with the Credit Information of the Second Person.

In some embodiments, the method includes the First Person registering with an online computer dating system.

In some embodiments, the method includes the First Person creating a profile.

In some embodiments, the method of includes the First Person initiating access to credit data and expressing permission for the online dating system to add the credit data to the profile.

In some embodiments, the method of includes the First Person expressing permission for the online computer dating system to make the credit data publicly available to other users of the online dating system.

In some embodiments, the method includes the First Person expressing permission for the online computer dating system to make the credit data privately available to the Second Person without making the credit data publicly available.

In some embodiments, the method includes the First Person expressing permission for the online computer dating system to communicate commercial offers to the First Person based on the credit data of the First Person.

In some embodiments, the method includes providing a numerical score for longterm relationship success.

What is claimed is:

1. An online dating system dating system, comprising:
a First User;
a Second User;
an electronic connection between the First User and the online dating system;
a display means;
an electronic connection between the Second User and the online dating system;
a means for determining Credit Information for the First User;
a means for determining Credit Information for the Second User;
comparing the Credit Information for the First User with the Credit Information for the Second User;
determining a Compatibility Score between the First User and the Second User.

2. The online dating system of claim 1, wherein the electronic connection comprises a personal computing platform connected to the internet.

3. The online dating system of claim 1, comprising a plurality of users having an electronic connection to the online dating system.

4. The online dating system of claim 1, wherein the Credit Information comprises data chosen from FICO score, debt, number of credit cards, bankruptcy.

5. The online dating system of claim 1, comprising profile information for the First User.

6. The online dating system of claim 5, wherein the profile information is chosen from age, gender, location, photo, race, children, height, hobbies, occupation, educational background, and personality characteristics.

7. The online dating system of claim 1, wherein the means for determining Credit Information comprises establishing an electronic connection with a credit bureau, querying the credit bureau for a record associated with the First User, and collecting the Credit Information.

8. The online dating system of claim 2, wherein the personal computing platform is chosen from a laptop computer, a desktop computer, a cell phone, or a mobile device.

9. The online dating system of claim 3, wherein the Credit Information for the First User is publicly available to the plurality of users connected to the online dating system.

10. The online dating system of claim 3, wherein the Credit Information for the First User is privately transmitted to the Second User without transmitting the Credit Information to the plurality of users.

11. The online dating system of claim 1, comprising Advertising Content.

12. The online dating system of claim 11, wherein said Advertising Content is presented to the First User.

13. The online dating system of claim 12, comprising presenting Advertising Content to the First User, pursuant to the Credit Information for the First User.

14. A method of matching a First Person with a Second Person for a committed relationship, comprising comparing the Credit Information of the First Person with the Credit Information of the Second Person.

15. The method of claim 14, comprising the First Person registering with an online computer dating system.

16. The method of claim 14, comprising the First Person creating a profile.

17. The method of claim 16, comprising the First Person expressing permission for the online computer dating system to access credit data and add the credit data to the profile.

18. The method of claim 16, comprising the First Person expressing permission for the online computer dating system to make the credit data publicly available to other users of the online dating system.

19. The method of claim 17, comprising the First Person expressing permission for the online computer dating system to make the credit data privately available to the Second Person without making the credit data publicly available.

20. The method of claim 17, comprising the First Person expressing permission for the online computer dating system to communicate commercial offers to the First Person based on the credit data of the First Person.

21. The method of claim 13, comprising providing a numerical score for longterm relationship success.
